(19) United States
(12) Patent Application Publication
(10) Pub. No.: US 2026/0080737 A1
(43) Pub. Date: Mar. 19, 2026

(54) Transfer Module

(71) Applicant: Lab2Fab, LLC, Fremont, CA (US)

(72) Inventors: Otalicio Pacheco da Cunha, JR., Lewisville, TX (US); Shawn Michael Lange, Walnut Creek, CA (US); John Paul Norman, San Jose, CA (US)

(21) Appl. No.: 19/331,468

(22) Filed: Sep. 17, 2025

Related U.S. Application Data
(60) Provisional application No. 63/696,779, filed on Sep. 19, 2024.

(51) Int. Cl. G07F 17/00; B25J 11/00

(52) U.S. Cl. CPC G07F 17/0078; B25J 11/0045

(57) ABSTRACT

An automated food system is provided that includes a vertically movable transfer module having an arm assembly with articulating arms and an end effector for transporting food items between storage, preparation, and cooking stations. The arm assembly is configured to extend laterally beyond the module frame and into a rack or adjacent station to retrieve or place items. A sensor mounted on the arm assembly detects spatial features of food items, enabling a processor to calculate location and size and control precise movement of the end effector. The system facilitates item transfer using coordinated vertical and planar motion based on sensor input.

### CROSS-REFERENCE TO RELATED APPLICATIONS

This application claims priority to U.S. Provisional Patent Application No. 63/696,779, filed September 19, 2024, and entitled “Transfer Module,” which is incorporated by reference herein in its entirety for all purposes.

### BACKGROUND

Systems have been developed for automated production of pizza and other food products or items. Merely as examples, automated food (e.g., pizza) production systems and methods are known from U.S. Provisional Patent Application No. 62/819,326 (filed on March 15, 2019), U.S. Patent Application No. 16/780,797 (filed on February 3, 2020), U.S. Patent Application No. 17/885,093 (filed on August 10, 2022), and U.S. Patent Application No. 17/885,104 (filed on August 10, 2022), each of which is hereby incorporated by reference in their entireties for all purposes.

Existing automated food production systems and methods can benefit from automating associated storage and/or movement systems and methods. For example, it can be beneficial to automate aspects of the temporary storage of food ingredients, e.g., unbaked pizza dough or unbaked assembled pizzas, or of completed food items, e.g., a baked pizza. In addition, it can be beneficial to automate loading and/or unloading of food items from storage areas to processing devices such as automated assembly devices, ovens, finishing stations, and the like.

However, existing solutions often require manual intervention or use rigid material handling systems that lack adaptability to variable food item sizes, access locations, or sequencing demands. Further, food preparation environments often have small or unique space footprints, limiting the types and dimensions of automation equipment that can be utilized in such environments. These limitations lead to inefficiencies, increased labor costs, and error-prone transfers, particularly in dynamic food service environments. Accordingly, there remains a need for an intelligent, adaptable, and space-efficient solution to automate the transportation of food items in multiple dimensions while accommodating a variety of rack structures and access point geometries.

### SUMMARY OF THE INVENTION

In at least some example approaches, an automated food system includes a rack having vertically spaced bays, each bay defined by a pair of laterally spaced horizontal supports that define an access spacing and are configured to receive and support a food item, and a food preparation station spaced from the rack. The automated food system additionally includes a first transfer module positioned adjacent the rack. The first transfer module includes a frame with vertical supports extending between a base and an upper frame member to form an enclosure with a defined lateral perimeter. The rack is located adjacent a first side of the frame and the food preparation station is located adjacent a second side. A vertical drive mounted to a third side of the frame includes a vertical track, a linear stage movable along the track, and a motorized drive to vertically displace the linear stage. An arm assembly mounted to the linear stage includes an arm base, first and second articulating arms connected at rotary joints, and an end effector mounted at a distal rotary joint. The movement of the arm assembly, through coordinated joint rotation, positions the end effector along a planar trajectory for inserting and retracting the food from the bays and the food preparation station, with the trajectory guided by a sensor and processor system that detects spatial features of the item and directs vertical and lateral movement accordingly.

In at least some example approaches, an automated food system includes a rack having vertically spaced bays, with each bay defined by a pair of laterally spaced horizontal supports forming a lateral access spacing configured to receive and support a food item. The automated food system additionally includes a first transfer module positioned adjacent the rack and includes a frame that defines a vertically oriented enclosure with a lateral perimeter. The transfer module includes a vertical drive mounted to the frame, the vertical drive having a vertical track, a linear stage movable along the track, and a motorized drive configured to vertically displace the linear stage. An arm assembly mounted to the linear stage includes an arm base extending outwardly, a first articulating arm coupled to the arm base via a first rotary joint, a second articulating arm coupled to the first arm via a second rotary joint, and an end effector mounted to the second arm via a third rotary joint. The rotary joints are configured to rotate their respective elements in a plane perpendicular to the vertical direction so that the end effector can move laterally beyond the frame’s perimeter and into the lateral access spacing of a rack bay. A sensor mounted on the arm assembly acquires data regarding the spatial features of the food item, and a processor determines the item’s location and controls both vertical and lateral motion of the end effector to retrieve the food item from the bay.

In at least some example approaches, a transfer module for use in an automated food system includes a frame defining a vertically oriented enclosure with a lateral perimeter, and a vertical drive mounted to the frame comprising a vertically extending track, a linear stage movable along the track, and a drive mechanism configured to displace the linear stage vertically. An arm assembly is coupled to the linear stage for vertical displacement and includes an arm base extending laterally from the stage, a first articulating arm rotatably mounted to the arm base at a first rotary joint, a second articulating arm rotatably coupled to the first arm at a second rotary joint, and an end effector rotatably mounted to the second arm at a third rotary joint. Each rotary joint is configured to rotate its respective component in a plane perpendicular to the vertical direction, enabling the end effector to extend laterally beyond the frame to access a food item. A sensor disposed on the arm assembly acquires distance measurements relative to the food item, and a processor determines the lateral position of the item and controls both the vertical displacement and joint articulation to position the end effector for engagement with the item.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 is a top plan view of an automated food system in accordance with an embodiment of the present disclosure.

FIG. 2 is a perspective view of the automated food system shown in FIG. 1.

FIG. 3 is a perspective view of a transfer module from the automated food system of FIGS. 1 and 2 in accordance with an embodiment of the present disclosure.

FIG. 4 is a side view of the transfer module shown in FIG. 3.

FIG. 5 is a schematic illustration of an automated food system in accordance with an embodiment of the present disclosure.

FIG. 6 is a fragmentary perspective view of the automated food system shown in FIGS. 1 and 2 in a first operating state in accordance with an embodiment of the present disclosure.

FIG. 7 is a fragmentary perspective view of the automated food system shown in FIGS. 1 and 2 in a second operating state in accordance with an embodiment of the present disclosure.

### DETAILED DESCRIPTION

Example illustrations herein are directed to a transfer module configured to transport food items of varying sizes in three dimensions through an integrated food preparation process. One or more transfer modules can be employed in an automated food system, e.g., for assembling and/or baking pizza or other food items through an automated food preparation process. Accordingly, food items transported by the transfer module can include partially completed pizzas, pizza doughs, or other food items (e.g., tortilla, flatbread, pita, or a base such as rice, noodles, or lettuce), which in some instances are loaded onto pans and/or bowls having a size and/or shape corresponding to the respective food item. The present disclosure will primarily be described in the context of prepared pizza dough located on pans, although it will be understood that transfer of different food items can be performed in accordance with the present disclosure and that multiple different types of food items can be handled by transfer stations as described herein (e.g., selectively transferring from multiple racks to an automated transfer station and/or an oven). In some examples, pizzas or pizza doughs can be produced in varying configurations, e.g., different sizes and/or shapes. As will be discussed further below, example transfer modules can be configured to transport the various size/shape food items, or different food item types.

Example systems can also include one or more racks or other temporary storage location configured to be positioned adjacent to a transfer module and/or other components of the automated food system. Racks can be generally complementary to the function of transfer modules within an automated food system, providing temporary storage for food items being processed in the automated food system. Based on the sensorized system described herein, a variety of racks or other temporary storage locations can be utilized, with the system dynamically adjusting to the type of rack and food items, and manner of temporary storage and other configurations, for use with other automated food preparation equipment. The racks can be configured to interface with access points for food items in the transfer module. For example, racks can have a plurality of locations therein that can be used to hold food items, which can be accessed by the transfer module when food items are needed, e.g., to be loaded into various processing devices in the automated food system. In some embodiments, the racks can also be configured with sensors or identification markers that facilitate communication with the transfer module, allowing the system to recognize rack configurations, available storage locations, or even identify specific food items by position or metadata tags. Examples of such sensorized racks systems are described, for example, in U.S. Patent No. 11,685,641 (issued June 27, 2023), entitled “Modular Automated Food Preparation System,” and U.S. Patent Application No. 18/920,040 (filed October 18, 2024), entitled “Mobile Racks for a Kitchen Environment,” both of which are hereby incorporated by reference herein in their entirety.

Accordingly, racks or other temporary storage locations can facilitate temporary storage, loading, unloading, and positioning of food items and food ingredients in an automated food system. Although in some instances racks can have standardized sizes, shapes, internal spacing, etc., in accordance with the present disclosure, a variety of rack sizes and shapes can be utilized based on flexible access points and angles of the transfer modules and “self-learning” of rack contents. Access points in an automated food system can include storage locations such as a bay within a storage rack, processing locations such as delivery or exit locations from processing devices (e.g., dispensers or ovens), or serving/finishing locations such as a rack for completed (e.g., assembled and/or baked) food items. This adaptability allows for seamless integration into existing food preparation environments without the need to standardize rack hardware or reconfigure surrounding equipment layouts.

Example transfer modules can be configured to transport food items in three-dimensional space between food storage and preparation equipment, as noted above. In some examples, movement of food items can be initiated by transfer modules in a vertical direction that can correspond to stacking of storage bays, trays, or the like in a rack or for processing devices in an automated food system. The transfer module can include a linear stage configured to move food items vertically up or down. The transfer module can also be configured to initiate planar movement of food items, e.g., to transport a food item from a first side of the transfer module to a different side of the transfer module using a wristed transfer arm. In this manner, a food item can be transferred from a rack to a processing device or vice versa. Planar and vertical movements are also combined. In some examples, a processing device in an automated food system can include an oven or an automated assembly device configured to apply ingredients. Planar movements of a food item can be provided by a wristed arm. The wristed arm can include a plurality of articulating arms connected at planarly rotating wristed joints, and an end effector configured to handle the food item. In one embodiment, each articulating joint can comprise a motorized rotary drive that permits three-hundred-and-sixty-degree rotation about a horizontal axis, providing a highly adaptable range of motion for the arm assembly. This configuration allows the end effector to approach or retract from access points at variable angles, including those with obstructions or asymmetric geometries.

The transfer module can transport food items within an enclosure defining multiple sides, e.g., where racks or processing devices can be positioned to provide and/or receive food items from the transfer module. In other examples, an enclosure is not present, and food items are planarly translated to a plurality of access points spaced angularly about the linear stage. The combination of planar and vertical movement paths enables efficient routing of food items between modules without the need for complex or large-footprint conveyor or robotic systems. This architecture further supports modular deployment of transfer modules in both linear and hub-and-spoke layouts.

The transfer modules can serve any food item transport roles in an automated food system that are convenient. Merely by way of example, a transfer module can retrieve uncooked or partially assembled food items from a storage rack and deliver them to an automated assembly station (e.g., performing functions such as dispensing toppings, etc.) or between assembly stations and further preparation locations (e.g., for slicing, baking, etc.). The automated food system can employ sensors or other identification features to ensure that correct items are retrieved by the transfer module, delivered in an appropriate order, etc. Transfer modules can also be used to transport food items to a rack or storage area in scenarios where the food items are ready to be served, e.g., fully assembled and baked pizza ready to be taken by a customer. In some implementations, the system can enforce logic-based queuing policies for transferring food items, allowing the module to account for preparation timelines, station readiness, and real-time load balancing across processing zones.

The transfer module and system described herein provide a versatile and efficient solution for transporting food items of varying sizes and shapes within an automated environment.

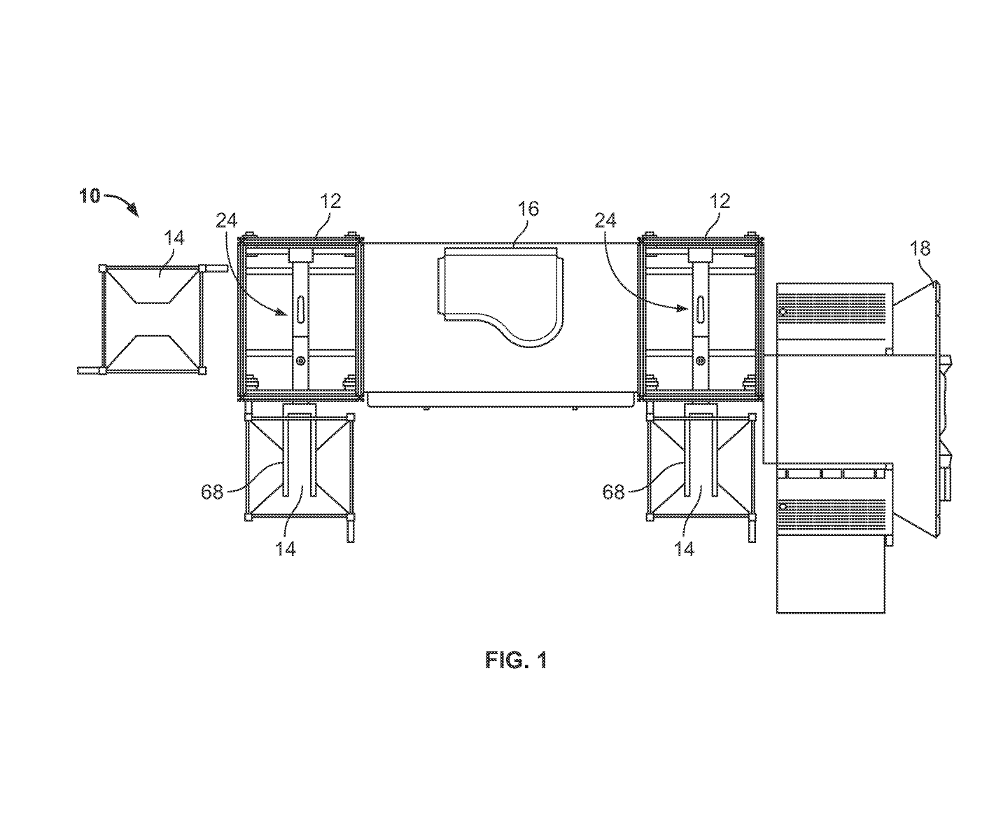

In one example embodiment shown in FIGS. 1, 2, and 5, an automated food system 10 can include transfer modules 12 and food stations, including food storage assemblies 14, a preparation station 16, and a cooking station 18. Transfer modules 12 can be located adjacent each of food storage assemblies 14, preparation station 16, and cooking station 18 and facilitate automated transfer of food items between food storage assemblies 14, preparation station 16, and cooking station 18. In the present embodiment, automated food system 10 is a modular system allowing repositioning of transfer modules 12, food storage assemblies 14, preparation station 16, and cooking station 18 relative to one another to facilitate a desired arrangement. This modular architecture supports easy customization and scalability of food system layouts depending on kitchen footprint, throughput needs, or changes in menu complexity. Transfer modules 12 can be mechanically and/or electrically connected to components of automated food system 10 for rapid reconfiguration or service replacement.

In the example shown, one transfer module 12 is positioned adjacent two food storage assemblies 14 and preparation station 16. Another transfer module 12 is positioned adjacent a food storage assembly 14, preparation station 16, and cooking station 18. This layout allows a first transfer module 12 to serve as the loading point for raw dough, while the second transfer module 12 facilitates handoff from assembly to cooking and ultimately to post-bake storage or service staging. This allows simultaneous, parallel processing across stations with minimal food item travel time or queuing bottlenecks.

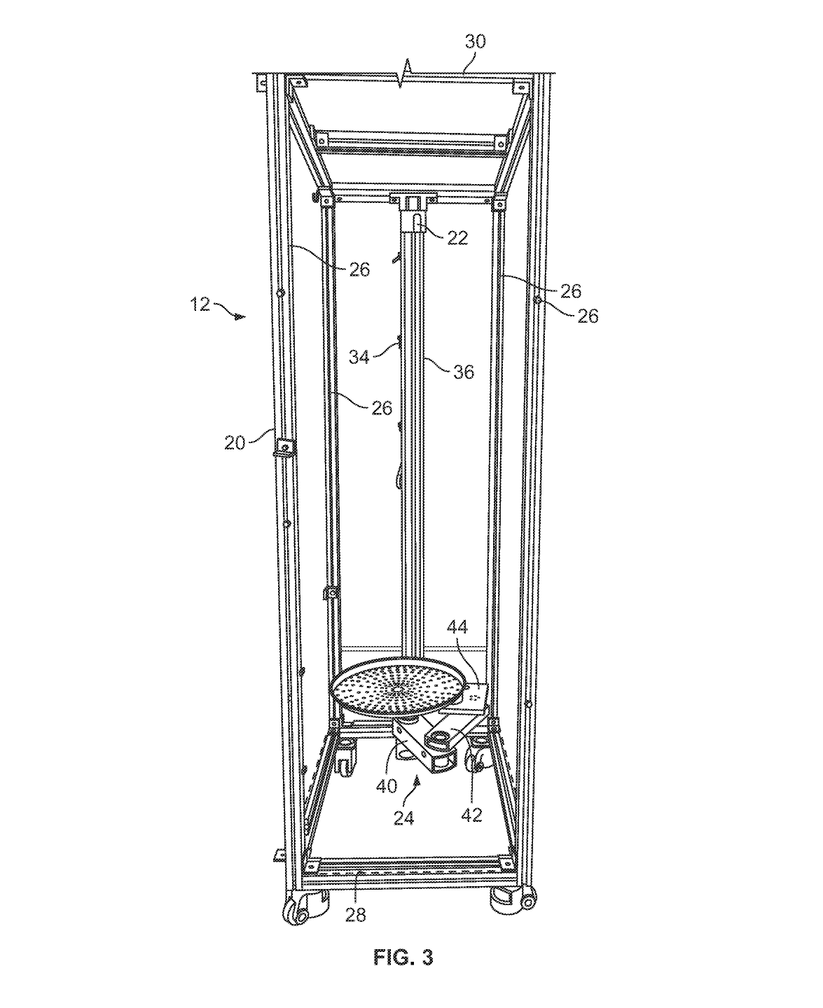

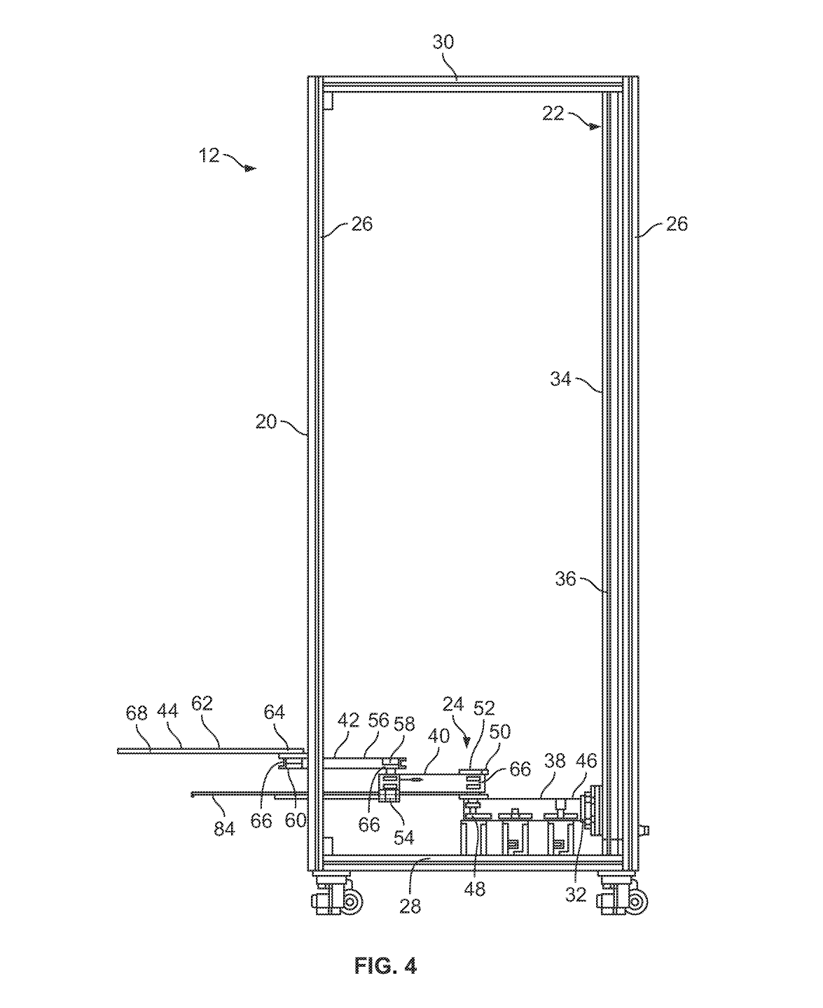

With additional reference to FIGS. 3 and 4, an example transfer module 12 is shown. Transfer module 12 can include a frame 20, a vertical drive 22 mounted to frame 20, and an arm assembly 24. In some embodiments, frame 20 can include vertical supports 26 extending between a base 28 and an upper frame member 30, forming an enclosure that generally defines an interior volume containing components configured to impart vertical and lateral planar movements to food items, such as vertical drive 22 and arm assembly 24. The enclosure can also facilitate a modular aspect of transfer module 12 by accommodating electrical or other power connections for components of transfer module 12, thereby simplifying replacement or maintenance of transfer module 12 in installed automated food systems 10. In the illustrated embodiment, frame 20 is shown as being open at its sides between vertical supports 26. However, frame 20 can alternatively be enclosed with openings as needed to interact with adjacent modules or can be arranged in a manner where a greater extent of the perimeter of frame 20 is unstructured (e.g., where some or all of vertical supports 26 may not be needed).

As another alternative, transfer module 12 can be of a different shape, such as a cylinder or half cylinder in order to reduce the number of vertical supports 26 that limit movement of arm assembly 24. Such structural flexibility enables adaptation of transfer module 12 to confined spaces or integration into systems with obstructed or non-linear access points.

Vertical drive 22 can include a linear stage 32 mounted to a track 34 for displacement via a drive mechanism 36. A variety of drive mechanisms can be used to move vertical stage 32 vertically along track 34, such as a belt-driven actuator, for example. Alternative drive options can be selected based on desired load capacity, stroke length, or environmental sealing requirements. Track 34 is mounted to frame 20 and, in some arrangements, track 34 can extend from base 28 of frame 20 and be structured in a manner that vertical supports 26 and upper frame member 30 are not needed to provide less restriction when arm assembly 24 is moved relative to frame 20.

With reference to FIGS. 3-7, arm assembly 24 can include an arm base 38, and first, second, and third articulating arms 40, 42, 44. Arm base 38 can define a first end 46 (proximal end) attached to linear stage 32 for vertical movement with vertical stage 32 and a second end 48 (distal end) opposite first end 46. Arm base 38, and first, second, and third articulating arms 40, 42, 44 form a wristed arm including multiple rigid members that are pivotally connected at the “wrists” to each other and that move with the linear stage, facilitating movement of the arm to extend and retract horizontally and to perform rotational movements within the plane perpendicular to the linear stage. Arm base 38 and first, second, and third articulating arms 40, 42, 44 can be modified to take a number of shapes (e.g., a curved shape) and can be sized for end-use applications. In some embodiments, the lengths and angular range of each segment can be optimized for specific payload weights, spatial constraints, or operational zones around transfer module 12. Arm geometry can also be adjusted to reduce torsional loading or to accommodate sensor cable routing through the interior of the arms.

Arm assembly 24 provides numerous benefits. Unlike rigid or single-axis designs, arm assembly 24 can reach around obstacles, access confined spaces, and adapt to changing configurations. This flexibility enables arm assembly 24 to dynamically adjust to variable rack geometries and food item positions, including those that are misaligned or offset from expected coordinates due to manual restocking or pan deformation. Arm assembly 24 allows for use with various types of racks, whether vertically stacked or laterally spread, and other equipment without requiring reconfiguration. Arm assembly 24 additionally provides benefits with respect to scalability by accommodating inclusion of additional transfer modules at different locations with different access points and functional requirements. Multiple articulating arms can operate in parallel or in coordinated handoff configurations, forming a distributed transfer network capable of serving multiple assembly and cooking stations concurrently. In high-volume food service environments, such modular and intelligent automation offers increased efficiency in operations.

In the present embodiment, arm base 38 extends in a direction perpendicular from linear stage 32. Second end 48 of arm base 38 is connected to a first end 50 of first articulating arm 40 via a first joint 52. Second end 54 of first articulating arm 40 is connected to a first end 56 of second articulating arm 42 via a second joint 58. Second end 60 of second articulating arm 42 is connected to a first end 62 of third articulating arm 44 via a third joint 64.

First, second, and third joints 52, 58, 64 each include a rotary drive 66 (e.g., rotationally controllable three-hundred-and-sixty-degree drive or motor) that connects arm base 38 and first, second, and third articulating arms 40, 42, 44 at first, second, and third joints 52, 58, 64, as discussed above. Rotary drive 66 can include a motorized rotary actuator with programmable angular control, enabling coordinated joint movement and reconfiguration of the arm’s extension and orientation. Drive 66 can be an electrical drive, e.g., using an AC or DC motor. Accordingly, in the example embodiment, transfer module 12 has a total of four motors including drive mechanism 36 for linear stage 32 to impart vertical or up/down movement to arm assembly 24 along vertical track 34, and three rotary drives 66 in first, second, and third joints 52, 58, 64 to rotate and horizontally translate end effector 68. However, this is not limiting and in other example approaches a different number of motors can be employed. For example, in other embodiments horizontal and/or rotational motion can be provided by only one or two motors.

A variety of electrical signals are routed through arm assembly 24 (e.g., via arm base 38, first, second, and third articulating arms 40, 42, 44, and first, second, and third joints 52, 58, 64) such that power, control signals, communication signals, and other electrical signals can be provided to control the respective movements of first, second, and third articulating arms 40, 42, 44 within the volume of transfer module 12 and outside of transfer module 12 to access, move, and place food items. Based on the respective dimensions of arm base 38 and first, second, and third articulating arms 40, 42, 44, arm assembly 24 is capable of fully extending in multiple directions to directly access space well outside of transfer module 12 while also being able to fully retract each of first, second, and third articulating arms 40, 42, 44 to consume a small space or profile within transfer module 12. In this manner, arm assembly 24 can access virtually any location adjacent to the internal volume of transfer module 12 and perform transfer movements between such locations, while maintaining a relatively minimal space or profile for transfer module 12.

In the example shown, first articulating arm 40 is located vertically above arm base 38, second articulating arm 42 is located vertically above first articulating arm 40, and third articulating arm 44 is located vertically above second articulating arm 42. The respective length of arm base 38 and first articulating arm 40 can be arranged such that first articulating arm 40 can rotate a full three-hundred-and-sixty degrees over arm base 38 without contacting linear stage 32 (assuming other portions and items engaged by the end effector do not extend further than the length of first articulating arm 40 during such movement). This clearance ensures that first joint 52 can articulate freely across its full range without mechanical interference, supporting wide reachability and flexibility of approach angles.

The respective lengths of first articulating arm 40 and second articulating arm 42 are such that second articulating arm 42 can rotate a full three-hundred-and-sixty degrees over first articulating arm 40 without contacting linear stage 32 while second articulating arm 42 is aligned with first articulating arm 40 (assuming the end effector items engaged by the end effector do not extend further than the length of the second rigid member during such movement). In some implementations, rotation limiters or soft stops can be programmed into the motion controller to prevent overextension based on the configuration of end effector 68 or enclosure geometry. In the example embodiment, the longitudinal extent of first articulating arm 40 is less than the longitudinal extent of arm base 38 and the longitudinal extent of second articulating arm 42 is greater than the longitudinal extent of first articulating arm 40. This staggered sizing allows arm assembly 24 to operate within confined spaces while still enabling sufficient extension to reach deep into racks or processing stations.

Third articulating arm 44 can form end effector 68 and can be rigidly attached and removable at third joint 64 to allow the changing out or modifying of end effector 68. In some examples, an attachment component can be located at third joint 64 above second articulating arm 42 to allow for attachment and detachment of different end effectors (e.g., via tabs, bolts, etc.). In other arrangements, end effector 68 can be a separate component attached to third articulating arm 44. This modularity permits customization of end effector 68 based on specific food item types, such as wide, narrow, or variable height items.

In some embodiments, the respective lengths of second articulating arm 42 and third articulating arm 44/end effector 68 are such that the third articulating arm 44/end effector 68 can rotate a full three-hundred-and-sixty degrees over the second articulating arm 42 without contacting linear stage 32 while first and second articulating arms 40, 42 are aligned with arm base 38. This rotational freedom enhances the ability to approach access points from alternative angles, reducing travel time and improving placement accuracy, particularly in high-density storage environments. Movements in addition to rotation at joints can include horizontal extension and retractions (e.g., with a linear stage), for example, at end effector 68.

End effector 68 can be configured in a manner to facilitate supporting or otherwise directly handling food items. In the example embodiment, end effector 68 includes a pair of tines 70 extending from a base 72. Tines 70 are spaced to securely hold food items during transport. In one embodiment, tine spacing can be fixed. In other embodiments, tine spacing can be dynamically adjustable through a servomechanical mechanism to accommodate variable-width pans or trays, enabling a single end effector to handle a range of food item dimensions.

In some implementations, the spacing between tines 70 and/or the orientation of tines 70 can be modified based on access needs and shape for a particular food item or vessel to be moved by transfer module 12. Base 72 of end effector 68 can be pivotally connected to second articulating arm 42 in the example embodiment, where end effector 68 forms third articulating arm 44. Alternatively, as noted above, end effector 68 can be a separate component that is removably connected to a distal end of third articulating arm 44, allowing or interchangeability of end effector 68 for a desired application. In either arrangement, end effector 68 allows for precise positioning of the food item as it is moved and navigated in and out of transfer module 12. Precision placement capabilities can be useful when inserting or retrieving food items from tightly spaced bays or loading into moving conveyors, reducing the risk of misalignment or dropped payloads. This can be helpful when maneuvering larger food items, e.g., larger pans, along complex movement paths, or within the enclosure or other areas of the system where there is limited space around the food item during transport.

The illustrated end effector 68, with a fork structure comprising tines 70 spaced apart from each other, can facilitate lifting and carrying food items of varying sizes and shapes, as well as interfacing with other components of the illustrated example automated food system. The spaced-tine configuration allows end effector 68 to engage trays or pans from underneath with minimal obstruction, providing mechanical stability while avoiding contact with the food surface. Further, the placement of end effector 68 at the end of arm assembly 24 can facilitate positioning of end effector 68 anywhere within the enclosure with the food item. In some embodiments, the wrist articulation of end effector 68 allows for angular correction during pickup or placement, enabling precise alignment with non-parallel surfaces or slanted racks. Accordingly, in some examples, food items can be retrieved by arm assembly 24 with end effector 68 along a first access point on a first external side (e.g., where a rack is positioned), and then carried by end effector 68 to a position within the enclosure.

Linear stage 32 can then lift or lower the food item within the enclosure to an appropriate vertical position, e.g., matching that of a second access point on a different external side of transfer module 12. This intermediate vertical repositioning allows for real-time compensation of differing equipment elevations, such as loading from low racks into high-entrance processing devices (or vice versa). End effector 68 can then be extended horizontally from linear stage 32 by the arm (e.g., by pivoting of the rigid members) to planarly move the food item to a different access point, e.g., an intake of a dispenser. Combined vertical and horizontal movements coordinated across linear stage 32 and articulating arms 40, 42, 44 enable end effector 68 to follow complex multi-axis trajectories with minimal dwell time or risk of collision.

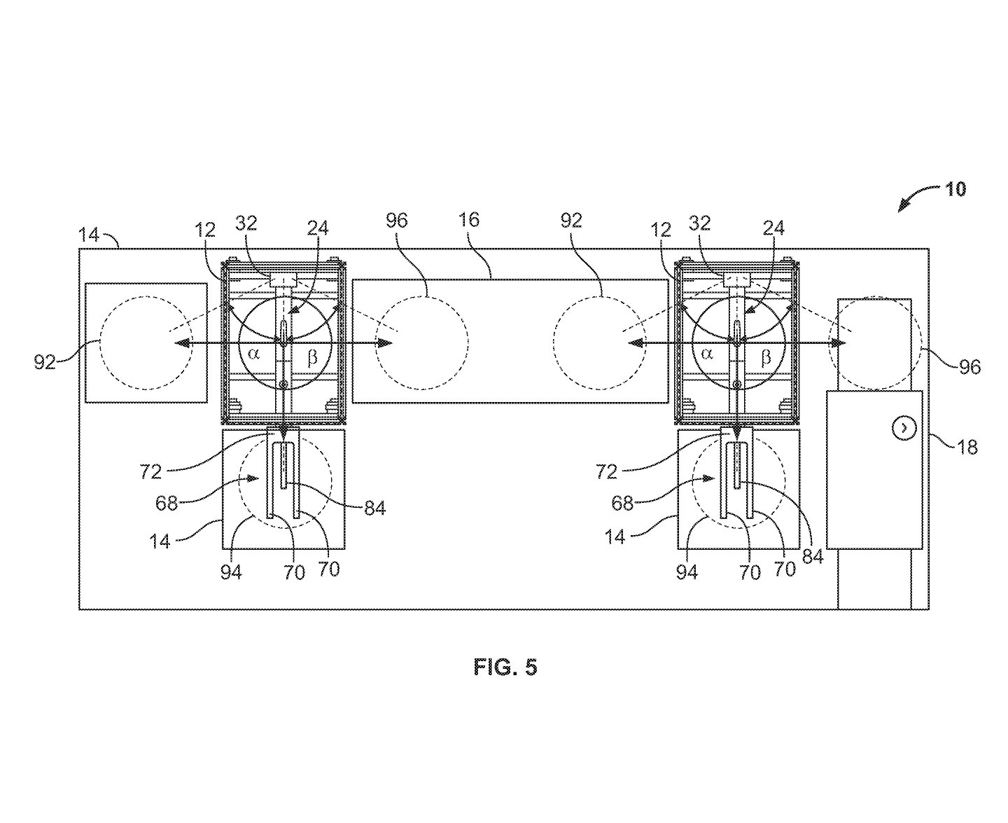

As seen in FIG. 5, each transfer module 12 has full flexibility to access any location adjacent to the entirety of three sides of transfer module 12. Access points at opposite sides of transfer module 12 can be spaced apart angularly by respective angles *** ERROR: No Symbol mapping for puaHex=61. Looks like α may have been intended. *** and *** ERROR: No Symbol mapping for puaHex=62. Looks like β may have been intended. *** about the linear stage 32 and vertical track 34. And, as noted above, variations are contemplated to provide even greater access. Angles *** ERROR: No Symbol mapping for puaHex=61. Looks like α may have been intended. *** and *** ERROR: No Symbol mapping for puaHex=62. Looks like β may have been intended. *** define the total operational sweep of the arm in the horizontal plane, bounded by the enclosure or other hardware limitations. These angles can represent the maximum practical range over which end effector 68 can reach without requiring rotation of the entire transfer module 12. Nevertheless, arm assembly 24 can also reach items outside of that range via articulation of one or more of first, second, and third articulating arms 40, 42, 44 from the fully extended position. The extended reach capability is enabled by coordinated control of the joints, allowing the arm to bend and reach backward or laterally around corners, thereby increasing flexibility without requiring reorientation of transfer module 12 or repositioning of racks (food storage assemblies 14).

Based on information such as self-learning of contents of food storage assemblies 14, assignment of target locations (e.g., access locations of automated food preparation equipment), and queueing requirements, transfer module 12 can enable automated transfer between numerous racks, automated equipment, manual stations, and the like, with additional flexibility provided by additional transfer modules 12 at additional locations. This self-learning functionality can be based on iterative scanning routines using onboard sensors.

In the example shown in FIGS. 4 and 5, a sensor 84 is located at second end 54 of first articulating arm 40. Sensor 84 may extend below second and third articulating arms 42,44 and end effector 68. Alternatively, sensor 84, or another sensor, may be located on second or third articulating arms 42,44 or end effector 68, depending on packaging constraints and mounting needs of the particular sensor. Sensor 84 can take a variety of forms, including, but not limited to, optical sensors, time-of-flight sensors, cameras, or other visual aids can be positioned to scan a food item before it is retrieved from an initial access point on a rack. Sensor 84 can be manipulated by arm assembly 24 and linear stage 32 to obtain information about adjacent racks and preparation equipment, for example, by performing a scan with a one-dimensional distance sensor.

In one example, transfer module 12 can include one or more sensors 84 to determine parameters associated with the food item. For example, the determined parameters can include a size and/or shape of the food item or tray to obtain information for understanding the environment of transfer module 12 (e.g., contents and locations racks, preparation equipment, etc.). These sensors can support autonomous decision-making by generating accurate spatial maps of storage configurations and confirming real-time food item positions prior to retrieval or placement. A processor of transfer module 12 can determine a distance to the food item based on the determined parameters and control lateral displacement of end effector 68 based on the determined distance. Distance calculation can be combined with orientation and depth data to determine the appropriate approach, minimizing error during extraction.

In some examples, sensor 84 can enter a scanning mode (e.g., in idle periods or in conjunction with known movements) to refresh environmental data and detect any manual changes to rack configuration or food item locations. Through a series of horizontal and vertical scans, location information of different racks (e.g., based on horizontal scan identifying rack supports and sizes) and rack contents (e.g., once a rack is located, three vertical scans to identify food item / pan / bowl sizes and locations). In this manner, the known location and placement of items prior to movement of arm assembly 24 for retrieval of the items allows arm assembly 24 and linear stage 32 to more quickly locate the item, even if it is partially misplaced or irregular. Pre-mapped coordinates and rack geometries can enable faster operation and ensure consistency across repeated pickup operations.

In some implementations sensor 84 can also be used during the final stages of the picking operation to fine tune the location of end effector 68 relative to the item to be selected. This fine-tuning can involve adjustments based on active feedback loops using proximity or contour-matching data, allowing the system to reliably capture items that have shifted or are loosely placed. These sensor-guided corrections can also support automatic determination of correct entry points for other system components, such as the pizza dispenser or oven, by locating openings, doors, or belt centers.

In some implementations, sensor 84 on arm assembly 24 can additionally or alternatively include multiple sensors such as combinations of cameras, time-of-flight, radar, and/or Lidar that are at a fixed location on transfer module 12. These fixed-position sensors can provide wide-angle or high-resolution imagery of racks, food items, or other components, supplementing the mobile sensor’s field of view and guiding its scanning trajectory. For example, video images can be captured and analyzed in real time to supplement and assist the operation of sensor 84 on arm assembly 24. The images can be utilized to initially analyze rack locations and to assist in the trajectory of sensor 84, which in turn can obtain high precision distance information through its scanning procedure. Vision processing can be used to detect rack type, confirm inventory presence, and track environmental changes between scans to detect human interaction or misalignment events.

The selection and removal of food items can be confirmed through image analysis, and events such as changing of a position of a food item or changing of the food item (e.g., by an employee switching out a pan) can be identified by video or other similar analysis, such that the system is aware that sensor 84 should rescan or scan during pickup at that location. In another example, a distance sensor, optical scanner, or the like can be employed in a topographical analysis of food items and other objects to determine needed movements to carry the food item from a current location to a desired location(s). This shape sensing can be used to detect food overhang, pan warping, or packaging obstructions, enabling end effector 68 to compensate or adjust its approach dynamically. Alternatively, or additionally, a sensor can be located near one of first, second, and third joints 52, 58, 64 in arm base 38 or one of first, second, and third articulating arms 40, 42, 44, or at end effector 68. For example, an optical or distance sensor can be located in or at an end of one of first, second, and third articulating arms 40, 42, 44. Accordingly, the distance sensor can be used to scan objects in the vicinity of or within transfer module 12.

Transfer module 12 can utilize self-learning capabilities to understand and internalize the organization and contents of items. This learning process allows transfer module 12 to map out the precise locations of various items and develop optimal strategies for retrieving and delivering them. Mapping can be stored in local memory or in a shared control system across multiple transfer modules 12, enabling coordination and load balancing. Additionally, transfer module 12 can integrate assignment logic for determining target locations, such as specific access points in automated food system 10. These can include other storage devices or processing stations that require exact placement or retrieval of items. Target assignments can be determined based on production stage, customer order sequence, preparation timing, and equipment readiness. Algorithms can be used to adjust operation based on machine feedback, task delays, or food station availability.

Based on this information, transfer module 12 can account for queueing requirements, making it aware of the sequence and timing in which various items need to be transferred. This provides increased efficiency for meeting the demands of multiple parallel tasks. Queuing logic can be implemented using real-time scheduling models that rank and dispatch transfer operations to minimize idle time at dependent processing stations and avoid collisions or starvation across modules. Arm assembly 24 can prioritize its movements based on availability of target equipment, or completion timelines at various stations, ensuring that automated food system 10 operates in a synchronized and optimized fashion.

The components of transfer module 12, including arm assembly 24 and linear stage 32, can be constructed with or coated at least in part by food-safe materials. Accordingly, these components can facilitate cleaning and sterilization, e.g., to comport with relevant commercial kitchen standards for cleanliness and sterility such as those promulgated by the National Sanitation Foundation (NSF). Further, assembly and disassembly of articulating arms 40, 42, 44 and end effector 68 to/from linear stage 32 can be accomplished with a relatively small number of components, e.g., via removable pins or the like, to facilitate removal for cleaning. For example, tool-less release mechanisms or quarter-turn fasteners can be employed to reduce downtime during sanitation cycles and simplify daily maintenance procedures for operators. Transfer module 12 can also avoid use of paints or greases that are not food-safe, and can avoid gaps, seams, or other areas for potentially trapping food particles.

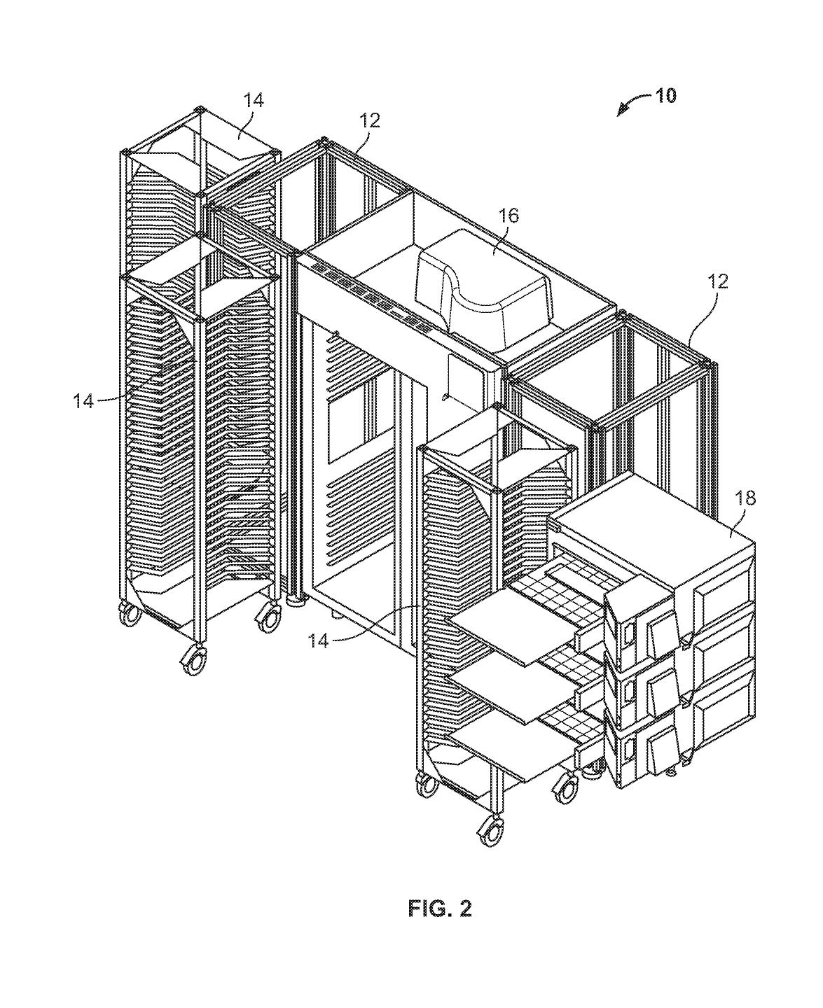

Referring back to FIGS. 1 and 2, as noted above, the example embodiment is illustrated in context of pizza preparation, where food storage assemblies 14 are racks that support pizza trays holding dough and/or prepared pizzas, preparation station 16 is an automated pizza assembly system, and cooking station 18 is a conveyor oven. Vertical track 34 and linear stage 32 can generally transport food items, e.g., a pan upon which pizza dough, assembled pizzas, flatbreads, baked/completed pizzas, etc., between different vertical heights or levels, thereby facilitating delivery of the food item between various access points in automated food system 10. This configuration supports vertical staging of ingredients or in-process items while maintaining a continuous flow across the preparation and cooking phases. This is not limiting, however, and example transfer modules 12 and systems can be employed for producing other foods, e.g., doughnuts, other food types, and combinations thereof.

Because transfer module 12 can be incorporated with generalized pan or tray handling and not item-specific mechanisms, it can be readily repurposed for alternative menus, including flatbreads, sandwich bases, baked desserts, or even non-baked assemblies in chilled service lines. As seen in FIGS. 1 and 2, transfer module 12 (leftmost) is adjacent two speed racks (food storage assemblies 14) and an automated pizza assembly system (preparation station 16). This adjacency enables efficient routing from raw dough storage to topping application with minimal arm movement and optimized vertical height matching between the rack bays and the station intake.

In the example embodiment, unbaked prepared dough of various types (e.g., thickness, shape, dough material) and sizes (e.g., diameter, area, non-uniform) can be located on the racks (food storage assemblies 14) which can, as needed, be loaded into the automated pizza assembly system (preparation station 16) by transfer module 12 for application of toppings such as sauce, cheese, pepperoni, or other meats and vegetables. The system can use size-detection routines to determine the precise footprint of each dough base prior to transfer.

An example automated pizza assembly system is described in further detail in U.S. Patent Application No. 16/780,797, which is hereby incorporated by reference in its entirety for all purposes. The disclosure in this prior application can be combined with the present embodiment to provide a fully integrated, end-to-end pizza preparation line. In the example, a linear stage transports pizza dough from an end of the automated pizza assembly system (preparation station 16) adjacent first transfer module 12 to an opposite end of the automated pizza assembly system (preparation station 16) adjacent a second transfer module 12 (rightmost). As noted above, second transfer module 12 is adjacent to the automated pizza assembly system (preparation station 16), and is also adjacent to another rack (food storage assembly 14) and the conveyor oven (cooking station 18). Second transfer module 12 receives assembled pizzas (e.g., including sauce, cheese, and other topping(s)) from the automated pizza assembly system (preparation station 16). This placement supports a linear flow model from storage through assembly to baking without requiring food item reversal or cross-path traffic, enhancing throughput and minimizing food handling complexity. The automated pizza assembly system (preparation station 16) can employ a linear stage configured to transport pizza dough on a linear stage path from first transfer module 12 to second transfer module 12.

In such examples, first transfer module 12 can be configured to load a pizza dough into a first end of the automated pizza assembly system (preparation station 16). Automated food system 10 can use alignment guides or staging platforms that accept the food item from above or from a horizontal handoff plane. Arm assembly 24 can retract once a sensor confirms receipt at the assembly intake. After assembling sauce, cheese, and/or other toppings, the assembled pizza can be dispensed from the opposite end of the automated pizza assembly system (preparation station 16) to second transfer module 12. Accordingly, after toppings are applied by the automated pizza assembly system (preparation station 16) to the pizza dough, second transfer module 12 can receive the assembled pizza.

Second transfer module 12 can load the assembled pizza into a rack (food storage assembly 14) for assembled pizzas, and/or to an oven, e.g., a conveyor oven, (cooking station 18) for baking. To deliver the pizza into the oven, end effector 68 can align the tray or pan with the entrance conveyor belt or shelf of the oven. In some embodiments, positional sensors or machine vision can assist in alignment. End effector 68 can release the item by retracting slightly while maintaining support until handoff is complete. Alternatively, a mechanical stop or guided insertion channel can interface with the edge of the pan, allowing the arm to place the item securely into the infeed path without disturbing oven temperature or conveyor alignment.

In some examples, second transfer module 12 can receive a baked pizza from the oven. This retrieval can occur at an output region of the oven, where arm assembly 24 is synchronized with the oven conveyor cycle and retrieves the tray after partial ejection, and can incorporate using proximity or thermal sensors to determine readiness for pickup. Second transfer module 12 can transport the baked pizza to a rack. In one example, second transfer module 12 can receive an assembled pizza from the automated pizza assembly system (preparation station 16) and load into the oven (cooking station 18) for baking, and subsequently can receive the baked pizza from the oven and place the baked/completed pizza into the rack (food storage assembly 14). Transfer modules 12 can manage positional differences between racks (food storage assemblies 14) and/or processing components in the system, such as an automated pizza assembly system (preparation station 16) and an oven (cooking station 18).

In one example, assembled pizzas can be produced at a different height by the automated pizza assembly system (preparation station 16) than an intake of the oven (cooking station 18), or a storage location for the assembled pizza in the rack (food storage assembly 14) adjacent the second/opposite end of the automated pizza assembly system (preparation station 16). Accordingly, second transfer module 12 can transport assembled or baked pizzas vertically and planarly to a storage position in the rack (food storage assembly 14). This height disparity can be resolved through the coordinated actuation of linear stage 32 and arm assembly 24, allowing end effector 68 to deliver or retrieve trays from devices at different elevations without compromising alignment precision. Movement profiles can be pre-programmed based on known equipment positions or adjusted via sensor feedback.

Transfer modules 12 can transport ingredients, e.g., a pizza dough, while processing devices are working, thereby reducing delays due to transport of ingredients. This enables automated food system 10 to decouple ingredient movement from device cycle timing, ensuring that materials are staged and ready before each station completes its task. For example, a pizza dough can be transported from a rack (food storage assembly 14) to an intake for the automated pizza assembly system (preparation station 16) at the same time the automated pizza assembly system (preparation station 16) is performing/completing assembly of toppings on another pizza dough. This capability allows for handling multiple pizzas simultaneously in different processing phases, e.g., dough retrieval, topping, baking, or holding, while maximizing throughput.

As seen in FIGS. 2, 6, and FIG. 7, racks (food storage assemblies 14) can each include vertically spaced storage bays 74, each serving as a storage location for food items. Bays 74 can each represent respective access points for the food items, to/from which a transfer module can 12 deliver/retrieve food items. Bays 74 can be defined by horizontally extending supports 76 defining a spacing 78 therebetween, which provide stable platforms for storing food items. Each bay 74 can be dimensioned to support a pan, tray, or bowl with adequate clearance above and below for end effector insertion and safe extraction, accounting for the thickness of both the carrier and food product. For example, pizza dough can generally be disposed vertically spaced from one another on trays in bays 74. Pans of pizza dough can be temporarily stored in bays 74 to provide a source for the automated pizza assembly system (preparation station 16) to assemble pizza toppings.

As discussed above, bays 74 can have a different vertical height or spacing from a floor surface compared with the automated pizza assembly system (preparation station 16) and/or oven (cooking station 18), which can receive pizza doughs at a given vertical and planar location above the floor surface. Accordingly, with additional reference to FIG. 1, first transfer module 12 can transport a tray having pizza in various states of completion (dough, assembled, cooked) vertically and laterally from a first position in a bay 74 to a second/different position where the automated pizza assembly system (preparation station 16) and/or oven (cooking station 18) receives the pizza doughs or where the tray is received from the automated pizza assembly system (preparation station 16) and/or oven (cooking station 18) by another transfer module 12 and placed in another one of bays 74.

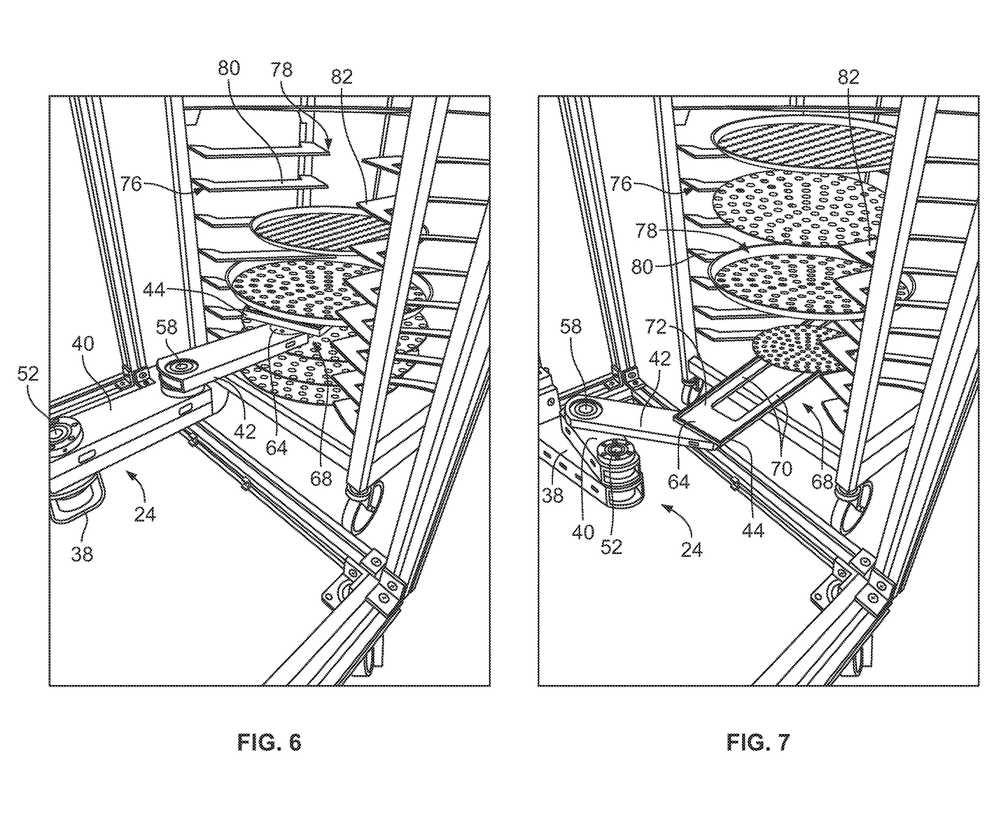

Interaction between transfer module 12 and a rack (food storage assemblies 14) is further illustrated in FIGS. 6 and 7. Horizontally extending supports 76 of bays 74 can accommodate food items of various sizes, shapes, and configurations. Each support 76 extends in a respective horizontal plane and includes first and second support members 80, 82 positioned opposite one another and defining horizontal support surfaces, such that a first end of a food item (e.g., a pizza pan) rests on first support member 80 while a second end of the food item opposite the first side rests on second support member 82 of the same bay 74. Spacing 78 defined by horizontal supports 76 between first and second support members 80, 82 allows the end effector 68 to pass laterally between the support surfaces and vertically between adjacent supports 76, e.g., when lifting food items from the first and second support members 80, 82. Accordingly, transfer module 12 can securely retrieve and transport food items without obstruction via end effector 68. In some implementations, sensor-guided alignment routines can adjust tine depth and angle in real time during approach, ensuring reliable capture even if the tray is slightly misaligned or warped.

End effector 68 is displaceable by articulating arms 40, 42, 44 in a first lateral direction to laterally align end effector 68 with the spacing between horizontal supports 76 and is displaceable by articulating arms 40, 42, 44 in a second lateral direction perpendicular to the first lateral direction to locate end effector 68 within spacing 78. This coordinated movement allows the system to approach bay 74 from multiple angles, facilitating entry even in asymmetric or variably spaced rack structures. Relative rotation of articulating arms 40, 42, 44 provides lateral displacement in the second lateral direction and a third lateral direction opposite the second lateral direction to remove the food item from the rack. By precisely controlling the angle and sequence of joint rotations, the system can extract the food item in a clean linear path or in an arc to avoid collisions with adjacent trays or rack components.

For example, first articulating arm 40 rotates about first joint 52 in a first rotational direction, third articulating arm 44 (and end effector 68) rotates about third joint 64 in the first rotational direction, and second articulating arm 42 rotates about second joint 58 in a second rotational direction opposite the first rotational direction when and end effector 68 is laterally displaced in the second lateral direction and a third lateral directions. This push-pull articulation provides both reach and retraction across a compact footprint, ensuring that the item is stably lifted and cleared from its resting position before vertical movement begins.

The longitudinal extent of end effector 68 can be generally parallel to first and second support members 80, 82 when extending into spacing 78. Rotation of first and second articulating arms 40, 42 aligns third joint 64 with spacing 78 and rotation of third articulating arm 44 (and end effector 68) about third joint 64 orients end effector 68 in a direction parallel to the second lateral direction. This ensures that end effector 68 enters with minimal angular deviation, reducing the chance of contact with rack walls or adjacent trays. The articulating arm arrangement allows for this parallel orientation regardless of the lateral entry point into the rack. This repositioning capability enables the same mechanical structure to engage a wide range of rack formats, including offset bays, asymmetrical access zones, or specialized shelving geometries. That is, the articulating arm arrangement allows for flexibility for use with a variety of items having different access points for arm assembly 24. Custom or nonstandard rack structures, such as sloped, curved, or modular systems, can also be served using trajectory recalculation and real-time arm articulation based on sensor input. Arm assembly 24 can laterally displace a food item on the rack (food storage assembly 14) from a first vertical position on the rack to a second vertical position different than the first vertical position on the rack. This also facilitates internal redistribution of items, allowing reorganization or consolidation of inventory within the same rack without operator involvement, supporting batch changes, cooling stages, or preparation zone handoffs.

The example racks illustrated can allow different size pizza pans. In the example illustrated, pizza pans can be employed of any size or shape so long as they are large enough to extend across the space between the horizontal supports, and small enough to fit within the enclosure. This flexible sizing approach enables operators to use standardized or custom trays across a wide product range, without requiring rack reconfiguration or dedicated fixtures for each pan format. Merely as examples, pizzas can be in round, square, or rectangular shapes, and can have a maximum dimension (e.g., a diameter of a circular pizza, or a maximum side length for a rectangular or square pizza) as small as 8 inches to 18 inches. For example, end effector 68 is shown receiving a first pan in FIG. 6 and a second pan in FIG. 7, which is smaller than the first pan. As explained further below, transfer module 12 can determine the size of a given tray and operate arm assembly 24 to provide the correct manipulation of articulating arms 40, 42, 44 and end effector 68 to retrieve and/or place the tray. Size-aware adjustment ensures precise centering and pickup, even when tray positioning is inconsistent or variable between rack levels.

In one example, sensor 84 can be positioned by arm assembly 24 to determine a location of three points around an outside of a pizza pan. The processor or controller of transfer modules 12 can be programmed to use scanned points to determine a size of the pizza pan and/or a center of the pizza pan, etc. to facilitate lifting the pizza pan with end effector 68. For example, the scanned points can be used to determine an arc containing the scanned points, which can be used to determine a circle defining the circular edge of the pizza pan, and/or a location of a centerpoint of the pizza pan. Arm assembly 24 can planarly translate the pan laterally from one access point 92 (e.g., an initial location of the pan) to another access point 94, 96 (e.g., a storage location on another rack, an intake or conveyor of an oven, etc.). Such planar translations can be executed by coordinating articulating arms 40, 42, 44 along a calculated path between origin and target, preserving item orientation and minimizing arc sweep to reduce cycle time and avoid obstructions.

Alternatively, transfer module 12 can be configured to communicate with the rack, e.g., to retrieve information regarding food items stored at particular bays or locations of the rack. This communication can be enabled by RFID, barcode, or wireless tag readers, allowing dynamic confirmation of item identity, size, or freshness data prior to retrieval. Other types of sensors can be employed alternatively or in addition. For example, a weight sensor can determine an overall size of a food item. Sensors can be in communication with other components of automated food system 10, or a controller of automated food system 10, to facilitate communication of instructions to transfer module 12. Integration with a centralized control system can allow for coordinated task scheduling, load balancing, and status reporting across all active modules in the kitchen environment. Transfer module 12 can be capable of identifying food items transported by transfer module 12, and/or positioned at corresponding access points. Item recognition can involve image classification models or encoded identifiers that link each tray to a set of parameters. For example, information regarding a size and/or shape of a food items, e.g., a given size/shape of a pizza, can be used to determine appropriate movements of one of articulating arms 40, 42, 44 and/or end effector 68 to provide a desired movement path to move the food item to a desired access point or location without contacting the enclosure or adjacent components of automated food system 10.

The foregoing is merely illustrative of the principles of this disclosure and various modifications can be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein can be modified or varied to optimize the systems, devices, apparatuses, components, and methods. Moreover, it will be understood that the systems, devices, apparatuses, components, and methods can have many applications such as monitoring of liquids other than water. The disclosed subject matter should not be limited to any single embodiment described herein, but rather should be construed according to the attached claims.

What is claimed is:

1. An automated food system comprising:
a rack including vertically spaced bays, each bay defined by a pair of laterally spaced horizontal supports that define a lateral access spacing configured to receive and support a food item;
a food preparation station spaced from the rack;
a first transfer module adjacent the rack and including:
a frame including vertical supports extending between a base and an upper frame member to form an enclosure defining a lateral perimeter, the rack located
adjacent a first side of the frame, and the food preparation station located adjacent a second side of the frame;
a vertical drive mounted to a third side of the frame and including:
a vertical track;
a linear stage configured for displacement along the vertical track; and
a motorized drive operably coupled to the linear stage to vertically displace the linear stage;
an arm assembly mounted to the linear stage and vertically displaceable therewith, the arm assembly including:
an arm base extending outwardly from the linear stage;
a first articulating arm rotatably mounted to a distal end of the arm base at a first rotary joint;
a second articulating arm rotatably connected to a distal end of the first articulating arm at a second rotary joint; and
an end effector coupled to a distal end of the second articulating arm at a third rotary joint;
wherein the first articulating arm is configured to rotate about the first rotary joint in a first rotational direction, the second articulating arm is configured to rotate about the second rotary joint in a second rotational direction opposite the first rotational direction, and the end effector is configured to rotate about the third rotary joint in the first rotational direction, such that, during lateral insertion and retraction, movement of the articulating arms and end effector cooperatively positions the end effector along a defined planar trajectory into and out of the bay and into and out of the food preparation station to transfer the food item from the rack to the food preparation station; and
a sensor disposed on the arm assembly and configured to acquire data indicative of spatial features of the food item; and
a processor configured to determine a location of the food item based on data from the sensor and control a combination of vertical and lateral displacement of the end effector to retrieve the food item from the bay and transfer the food item to the food preparation station.

2. An automated food system comprising:
a food station configured to receive and support a food item;
a first transfer module adjacent the food station and including:
a frame defining a vertically oriented enclosure and a lateral perimeter;
a vertical drive mounted to the frame and including:
a vertical track;
a linear stage configured for displacement along the vertical track; and
a motorized drive operably coupled to the linear stage to vertically displace the linear stage;
an arm assembly mounted to the linear stage and vertically displaceable therewith, the arm assembly including:
an arm base extending outwardly from the linear stage;
a first articulating arm rotatably mounted to a distal end of the arm base at a first rotary joint;
a second articulating arm rotatably connected to a distal end of the first articulating arm at a second rotary joint; and
an end effector coupled to a distal end of the second articulating arm at a third rotary joint;
wherein each of the first, second, and third rotary joints is configured to rotate in a plane perpendicular to a direction of the vertical displacement such that the end effector is displaceable laterally beyond the lateral perimeter of the frame into the food station; and
a sensor disposed on the arm assembly and configured to acquire data indicative of spatial features of the food item; and
a processor configured to determine a location of the food item based on data from the sensor and control a combination of vertical and lateral displacement of the end effector to retrieve the food item from the food station.

3. The automated food system of claim 2, wherein the food station includes a rack with vertically spaced bays, each bay defined by a pair of laterally spaced horizontal supports that define a lateral access spacing, the arm assembly configured to displace the end effector in a first lateral direction to align the end effector with the lateral access spacing between the horizontal supports of a selected bay and in a second lateral direction, orthogonal to the first lateral direction, to insert the end effector into the access spacing to engage a food item.

4. The automated food system of claim 3, wherein coordinated rotation of the first and second articulating arms causes the end effector to move in the second lateral direction and, upon reversal, in a third lateral direction opposite the second lateral direction to withdraw the food item from the bay.

5. The automated food system of claim 2, wherein the first articulating arm comprises a proximal end rotatably coupled to a distal end of the arm base at the first rotary joint, the second articulating arm comprises a proximal end rotatably coupled to a distal end of the first articulating arm at the second rotary joint and the end effector is rotatably coupled to a distal end of the second articulating arm at the third rotary joint.

6. The automated food system of claim 5, wherein the first articulating arm is configured to rotate about the first rotary joint in a first rotational direction, the second articulating arm is configured to rotate about the second rotary joint in a second rotational direction opposite the first rotational direction, and the end effector is configured to rotate about the third rotary joint in the first rotational direction, such that, during lateral insertion and retraction, movement of the articulating arms and end effector cooperatively positions the end effector along a defined planar trajectory into and out of the food station.

7. The automated food system of claim 6, wherein the processor is further configured to adjust an extent of lateral displacement of the end effector into the food station based on a determined position of the food item determined based on the data acquired by the sensor.

8. The automated food system of claim 7, wherein a longitudinal extent of the first articulating arm is less than a longitudinal extent of the arm base, such that the first articulating arm is fully retractable within the lateral perimeter of the frame when not in use.

9. The automated food system of claim 8, wherein a longitudinal extent of the second articulating arm is greater than the longitudinal extent of the first articulating arm, such that the second articulating arm provides an extended reach into the food station beyond the first articulating arm.

10. The automated food system of claim 5, wherein rotation of at least one of the first and second articulating arms positions the third rotary joint in alignment with the food station and rotation of the end effector about the third rotary joint orients the end effector in a direction to enable insertion into the food station.

11. The automated food system of claim 2, wherein the food station includes a rack with vertically spaced bays, each bay defined by a pair of laterally spaced horizontal supports that define a lateral access spacing, and further comprising a food preparation station disposed adjacent the transfer module and spaced from the rack, wherein the arm assembly is configured to retrieve a food item from a bay of the rack and laterally displace the food item across the lateral perimeter of the frame to the food preparation station at a different vertical position from the bay.

12. The automated food system of claim 2, wherein the sensor is configured to detect lateral distances to three or more spatially distinct points on the food item and the processor is configured to calculate a size characteristic of the food item based on geometric relationships among the points and to adjust lateral displacement of the arm assembly based on the calculated size.

13. The automated food system of claim 12, wherein the food item includes a circular tray and the processor is configured to determine a diameter of the tray by fitting an arc through the three points to determine a circular boundary.

14. The automated food system of claim 2, wherein the frame comprises vertical supports extending between a base and an upper frame member to form an enclosure, the vertical drive is mounted to a first side of the frame, the food station including a rack located adjacent a second side of the frame, and further comprising a food preparation station located adjacent a third side of the frame, wherein the arm assembly is configured to extend laterally beyond the enclosure into each of the rack and the food preparation station.

15. The automated food system of claim 14, further comprising a second transfer module disposed adjacent the food preparation station on a side opposite the first transfer module and a cooking station positioned adjacent the second transfer module, wherein the second transfer module is configured to receive a food item from the food preparation station and transfer the food item to the cooking station.

16. A transfer module of an automated food system, the transfer module comprising:
a frame defining a vertically oriented enclosure and a lateral perimeter;
a vertical drive mounted to the frame and including:
a vertically extending track;
a linear stage movable along the track; and
a drive mechanism configured to displace the linear stage vertically along the track;
an arm assembly coupled to the linear stage for vertical displacement therewith, the arm assembly including:
an arm base extending laterally from the linear stage;
a first articulating arm rotatably mounted to a distal end of the arm base at a first rotary joint;
a second articulating arm rotatably coupled to a distal end of the first articulating arm at a second rotary joint;
an end effector rotatably mounted to a distal end of the second articulating arm at a third rotary joint;
wherein each of the rotary joints is configured to provide rotation in a plane perpendicular to a direction of the vertical displacement such that the end effector is displaceable laterally beyond the lateral perimeter of the frame;
a sensor disposed on the arm assembly and configured to acquire distance measurements relative to a food item; and
a processor configured to determine a lateral position of the food item based on the distance measurements and to control coordinated rotation of the articulating arms and vertical displacement of the linear stage to position the end effector for engagement with the food item.

17. The transfer module of claim 16, wherein the arm assembly is configured to move the end effector in a first lateral direction to align with an access spacing of a rack bay and in a second lateral direction, orthogonal to the first lateral direction, to insert the end effector into the access spacing.

18. The transfer module of claim 16, wherein the processor is further configured to control a trajectory of the end effector based on a calculated size of the food item determined by three scanned points on the food item.

19. The transfer module of claim 16, wherein the first articulating arm is configured to rotate in a first direction about the first rotary joint, the second articulating arm is configured to rotate in a second direction opposite the first direction about the second rotary joint, and the end effector is configured to rotate in the first direction about the third rotary joint, such that cooperative rotation of the articulating arms positions the end effector along a defined planar path.

20. The transfer module of claim 16, wherein the frame is configured for multi-sided access, with the arm assembly extendable laterally beyond the lateral perimeter of the frame to reach into a storage rack on a first side of the frame and a food preparation station on a second side of the frame.
